(19) United States
(12) Patent Application Publication
(10) Pub. No.: US 2002/0135805 A1
(43) Pub. Date: Sep. 26, 2002

(54) Communications system and method for supporting a technology provider of a communications network

(76) Inventors: Christer Fahraeus, Lund (SE); Stefan Lynggaard, Lund (SE); Micco Gronholm, Helsingborg (SE)

Correspondence Address: BIRCH STEWART KOLASCH & BIRCH, PO BOX 747, FALLS CHURCH, VA, 22040-0747, US

(21) Appl. No.: 10/101,746

(22) Filed: Mar. 21, 2002

Related U.S. Application Data
(60) Provisional application No. 60/304,740, filed on Jul. 13, 2001.
(60) Provisional application No. 60/277,285, filed on Mar. 21, 2001.
(60) Provisional application No. 60/281,786, filed on Apr. 6, 2001.

(51) Int. Cl. G06F 15/00

(52) U.S. Cl. 358/1.15

(57) ABSTRACT

A system for inputting and communicating information via a network includes: a position indicia reading stylus that collects position information from a product having position defining indicia printed thereon, the position information representing the position of the stylus on the product, and a network infrastructure for communicating a signal that represents, or is derived from, the collected position information to a network node that performs a technological process based on the signal. Funds for supporting the network node are derived from a licensing arrangement associated with at least one of the product having position defining indicia and the stylus. According to one embodiment of the present invention, the network node is a technological service provider who has a proprietary interest in stylus/digital paper technology and who establishes a licensing arrangement with at least manufacturers/suppliers of digital paper and/or stylus units. Costs associated with the technological service are pre-paid by the end user, such that the technological service provider does not later charge a periodic or use based fee to the end user. In this way, the end user is not subjected to potentially confusing and inconvenient fee and billing arrangements associated with stylus/digital paper based services.

### CROSS-REFERENCE TO RELATED APPLICATIONS

This application claims priority under 35 U.S.C. §119 of U.S. Provisional Applications No. 60/304,740, entitled Communications System and Method for Supporting a Technology Provider of a Communications Network and filed on Jul. 13, 2001, No. 60/277,285, entitled Communications Services, Methods and Systems and filed Mar. 21, 2001, and No. 60/281,786, entitled Methods and System for Communications Service Revenue Collection and filed Apr. 6, 2001, the entire contents of which are incorporated herein by reference.

### BACKGROUND OF THE INVENTION

1. Field of the Invention

The present invention relates generally to communications and, more particularly, to a communications system and a method for supporting a technology provider of a communications network.

2. Background Information

Computers and other communications devices that are connected via a network, such as the Internet, allow individuals to electronically communicate, access information and services, and conduct various business transactions. For example, Email has become a predominant tool for message transmission for both personal use and for businesses, and the use of Internet web sites for accessing information, goods, and services has become a part of daily life for many people in recent years.

The manner in which a network may be accessed, and the user interface employed, can vary. For example, a user often accesses a mobile phone network after manipulating keys on the mobile phone, or in some instances through voice commands. Network access through a personal digital assistant (PDA) may be achieved using a stylus on a touch-sensitive surface, and network access through a personal computer or laptop is often achieved through a keyboard or mouse.

As input technology has advanced, and as network access becomes easier through the proliferation of, for example, localized proximity oriented communication/network access protocols like Bluetooth, conventional network based communications and transactions might be impeded by input devices and interfaces that users find cumbersome or awkward. Further, with the diversity of fee based services provided over, for example, the Internet, and the corresponding diversity of input technologies or at least types of inputs or destinations which a given input technology may access, and with the relative infancy of such fee based services, problems may arise in proliferating a particular input technology to users and/or prompting its use to a level that encourages the provisioning of new services.

In particular, attempts by a developer of a new input technology, or by service providers associated with a new input technology, to charge periodic or use based fees to end users may discourage users from buying into or using the new input technology. In addition, problems may arise in fee collection for transactions associated with the provision of services in a computer network due to other factors, such as the existence of an intermediate service provider between an end user and the actual fee based service provider. Direct billing for individual fee based services can create problems for subscribers in that a different bill may be received for each separate input technology and from each separate service provider. Fee and billing arrangements that unduly burden, confuse, or inconvenience subscribers will discourage users from obtaining and using the new input technology.

### SUMMARY

The present invention is a system for inputting and communicating information via a network, the system including: a position indicia reading stylus for collecting position information from a product having position defining indicia printed thereon, the position information representing the position of the stylus on the product; and a network infrastructure for communicating a signal that represents, or is derived from, the collected position information to a network node that performs a technological service. Funds for supporting the network node that performs the technological service are derived from a licensing arrangement associated with at least one of the product having position defining indicia and the stylus. The present invention is also a method of offsetting costs associated with a technology service in which an end user uses a position indicia reading stylus to collect position information from a product having position defining indicia thereon and a network infrastructure communicates a signal representing, or derived from, the position information to a network node that performs a technological service based on the received signal. The method includes providing at least one of the product having position defining indicia and the stylus to end users pursuant to a licensing agreement that funds the network node performing the technological service.

The present invention is also a method of controlling access to communications services, the method including: receiving position information from a position indicia reading stylus, the stylus collecting position information from a product having position defining indicia printed thereon, the position information representing the position of the stylus on the product; determining whether the received position information corresponds to previously-assigned identification information and, if so, retrieving service management information designated for the previously-assigned identification information; and selectively permitting access to a communications service in accordance with the retrieved service management information. The present invention is also a system for controlling access to communications services, the system comprising: an input for receiving position information from a position indicia reading stylus, the stylus collecting position information from a product having position defining indicia printed thereon, the position information representing the position of the stylus on the product; and a processor for determining whether the received position information corresponds to previously-assigned identification information and, if so, retrieving service management information designated for the previously-assigned identification information, the processor selectively permitting access to a communications service in accordance with the retrieved service management information.

According to one embodiment of the present invention, the network node is a technological service provider who has a proprietary interest in stylus/“digital paper” technology and who has established a licensing arrangement with at least one of the manufacturers/suppliers of digital paper and/or stylus units. In one implementation of the present invention, when an end user purchases digital paper from a licensed supplier, costs associated with the technological service are “pre-paid,” such that the technological service provider does not later charge a periodic or use based fee to the end user. In this way, the end user is not subjected to potentially confusing and inconvenient fee and billing arrangements associated with stylus/digital paper based services, thereby encouraging the use of stylus/digital paper technology. Increased use of the stylus/digital paper based services facilitates proliferation and acceptance of stylus/digital paper as a viable input technology.

### BRIEF DESCRIPTION OF THE DRAWINGS

Further objects, features and advantages of the invention will become apparent from the detailed description given below by reference to the accompanying drawings, which are incorporated in and constitute a part of the specification and, together with the description, explain the features and principles of the invention. In the drawings:

FIG. 1 is a diagram of an exemplary network environment to which principles of the present application may be applied;

FIG. 2 is a diagram showing exemplary features of the network environment of FIG. 1 in more detail to demonstrate a possible end user environment to which principles of the present application may be applied;

FIG. 3 is a diagram showing an exemplary flow of information among a plurality of network nodes in the context of the exemplary end user environment shown in FIG. 2;

FIG. 4A is a diagram a several exemplary fee arrangements for the exemplary network environment of FIG. 1;

FIG. 4B is a diagram showing sources and recipients of fees and revenue in a technological environment associated with the present invention; and

FIG. 5 is a diagram of an arrangement for verifying authenticity and preventing unlicensed use of pre-paid digital paper according to an embodiment of the present invention.

### DETAILED DESCRIPTION

The present invention is a communications system and a method of supporting a technology provider of a communications network. The present invention is also a system and a method for controlling access to communications services. The present invention will be described below with reference to the accompanying drawings.

1. Exemplary Network Arrangement and Services

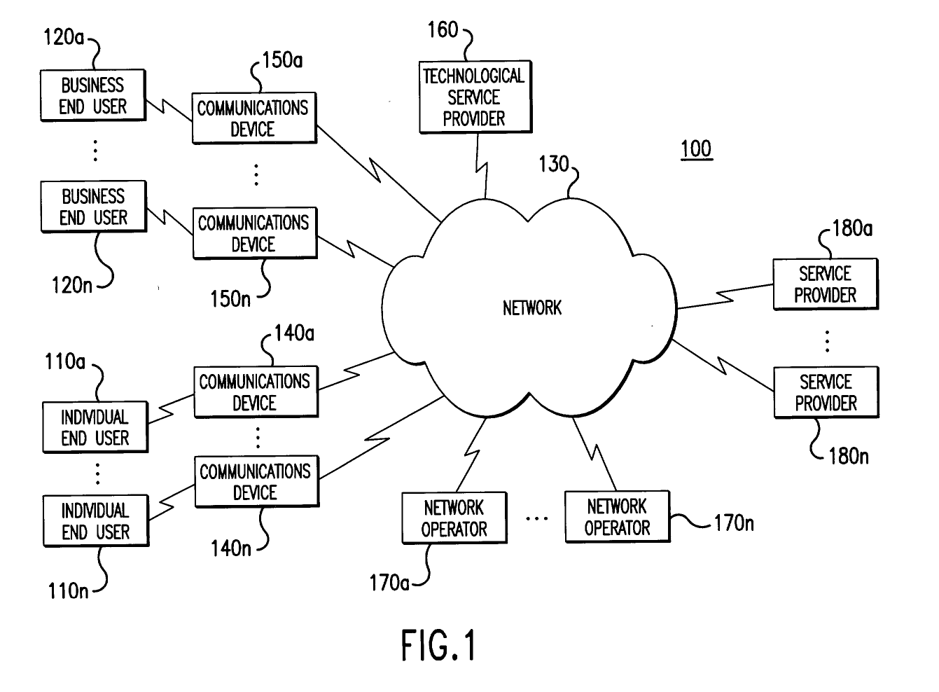

FIG. 1 illustrates an exemplary network environment to which principles of the present invention may be applied. As seen in FIG. 1, an exemplary network environment 100 includes the following main components: (1) individual end users 110a-110n; (2) business end users 120a-120n; (3) a network 130; (4) communications devices 140a-140n, respectively providing communications connections between the individual end users 110a-110n and the network 130; (5) communications devices 150a-150n, respectively providing communications connections between business end users 120a-120n and the network 130; (6) a technological service provider 160; (7) network operators 170a-170n; and (8) service providers 180a-180n. It should be readily apparent that the number and types of components in network environment 100 are not limited to what is shown in FIG. 1. For example, there may be several technological service providers.

The communications devices 140a-140n, 150a-150n, the technological service provider 160, the network operators 170a-170n, and the service provider 180a-180n are connected via the network 130, thereby enabling the exchange of information and services among these components. The network 130 may be any type of network or a combination of networks, for example having cellular wireless, landline, and/or satellite components, individually or in combination. Furthermore, although the technological service provider 160, the network operators 170a-170n, and the service providers 180a-180n are shown as discrete entities of the network environment 100, it should be recognized that the functionality of these components, discussed below, may be consolidated, such that a single entity may function as both a technological service provider and a service provider, both a technological service provider and a network operator, both a service provider and a network operator, or as a technological service provider, a service provider, and a network operator.

Network operators 170a-170n may be entities that provide end users 110a-110n, 120a-120n, technological service provider 160, and service providers 180a-180n with channels of the network 130 over which to communicate, e.g., communications services providers.

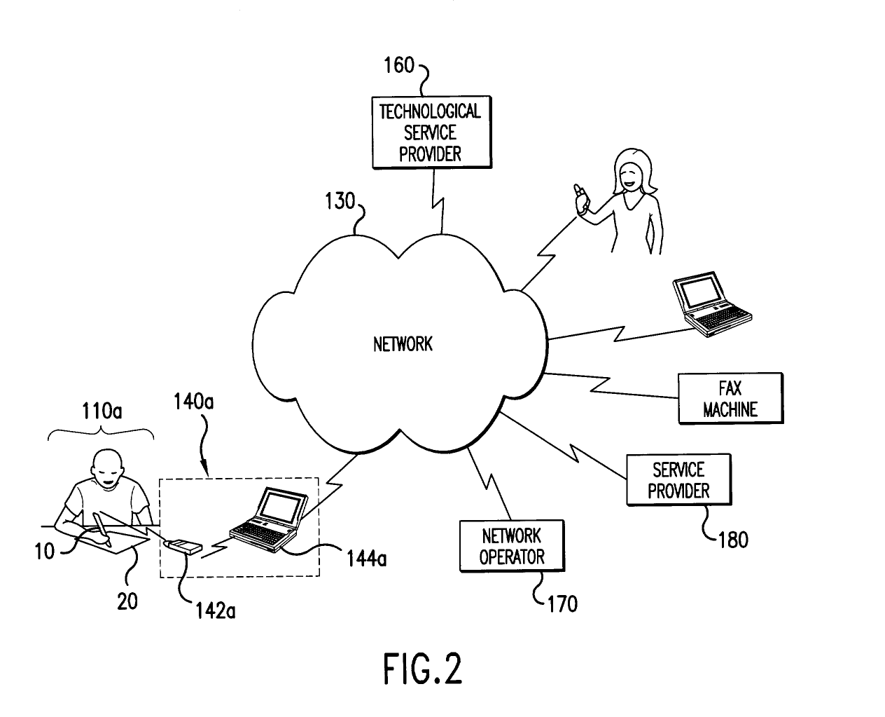

FIG. 2 is a diagram showing components of the network environment of FIG. 1 in more detail to demonstrate a possible end user environment to which principles of the present application may be applied. According to the exemplary end user environment shown in FIG. 2, an individual end user 110a uses a position indicia reading handheld device, such as a pen or stylus 10 that is able to read position indicia from a surface 20. The surface 20 that has position defining indicia thereon will be referred to herein as “digital paper,” although it should be recognized that the surface 20 is not strictly limited to a paper product. As the user moves the stylus 10 across the digital paper 20, the stylus 10 detects position defining indicia to determine position/movement of the stylus 10 on the digital paper 20 and sends a signal representing, or derived from, position/movement of the stylus 10 via the communications device 140a associated with the individual end user 110a and the network 130 to the technological service provider 160, a network operator 170, a service provider 180, and/or other entities connected to the network 130. In the exemplary end user environment illustrated in FIG. 2, the communications device 140a includes a mobile phone 142a and a personal computer 144a. This arrangement for the communications device 140a is just one possibility. As described in greater detail below, the stylus/digital paper input technology that is the subject of this application enables a variety of services and applications.

The digital paper 20 may have an absolute-position-defining background pattern printed thereon, e.g., printed on the paper 20 using carbon-based black ink or another ink visible by infrared light. Such a pattern may include dots with a nominal spacing of, e.g., 0.3 mm and may be printed on paper of any desired size and shape. The dots may be slightly displaced from a virtual grid structure to form areas or windows, for example including 6×6 dots and occupying a dimension of 2×2 mm. Such an area, which may be called a “symbol,” uniquely defines an absolute position at an imaginary surface. Since each dot may occupy four different positions and since there are 36 dots, the total combination of positions that can be coded is 2⁷², which corresponds to a surface area exceeding 60×10⁶ km². In this way, the imaginary surface may be divided into numerous sub-surfaces of various sizes, some of which may be pre-defined for certain applications, such as those discussed below, while others may be licensed to companies and/or authorities. A more detailed description of position defining characteristics for a particular form of digital paper 20 is provided in U.S. application Ser. No. 09/580,338, titled “Position Determination,” filed May 26, 2000 and U.S. application Ser. No. 09/676,914, titled “Position Determination II—Graphic,” filed Oct. 2, 2000, such description being herein incorporated by reference. The area within a sub-surface can be used for a range of applications, each with its own assigned functionality. In addition to position-defining portions, portions of the digital paper 20 may be provided with dot patterns that represent particular functions, commands, or information fields.

The stylus 10 may be a “digital pen” having the following elements: (1) a camera including light emitting diodes that illuminate dots of the surface 20, e.g., via infrared light, and takes digital snapshots, e.g., at a rate of 100 per second, to capture images of the illuminated dots; (2) an image processor that calculates, e.g., in real-time, the position/movement/orientation of the stylus 10 on the surface 20 based on the dot pattern images captured from the surface 20; (3) a memory for storing coordinate information generated by the image processor, e.g., sufficient to store several hand-written pages; (4) a communication element, e.g., a wireless Bluetooth RF transceiver or an infrared transceiver, for sending/receiving information to/from the associated communications device 140a, or directly to the network 130; (5) an ink cartridge; (6) a force sensor that measures stylus tip force; and (7) a battery. One of skill in the art will recognize that the stylus 10 may include additional or fewer components. It should also be recognized that the stylus 10 may include a transmitter for communicating directly over a network, instead of merely a transmitter for relaying information over a network through an intermediary communications device, such as a mobile telephone, or a network connected computer or PDA. The information transfer by the transceiver of the stylus 10 does not need to be wireless, but instead may be by cable. A more detailed description of a position determining function that may be performed by the stylus 10 is provided in U.S. application Ser. No. 09/580,338, titled “Position Determination,” filed May 26, 2000 and U.S. application Ser. No. 09/676,914, titled “Position Determination II—Graphic,” filed Oct. 2, 2000, such description being herein incorporated by reference.

Carbon-based black, or other suitable, ink which may form the dot patterns on the surface 20 may be capable of absorbing infrared light emitted from the stylus 10 so that the position identifying patterns on the surface 20 may be read by the stylus 10 regardless of other colors, or noncarbon-based black ink, printed thereon, provided the other colors do not absorb infrared light. In addition to detecting position/movement/orientation of the stylus 10 and recognizing function/field-identifying patterns, the stylus 10 may include intelligent character recognition (ICR) capabilities for interpreting letters and characters written in certain fields of the digital paper 20, e.g., for reading handwritten email addresses, fax numbers, or phone numbers. Although an individual end user 110a is illustrated in FIG. 2, business end users 120a-120n may likewise use a position indicia reading stylus 10 and a surface 20 having position defining indicia thereto to conduct business functions.

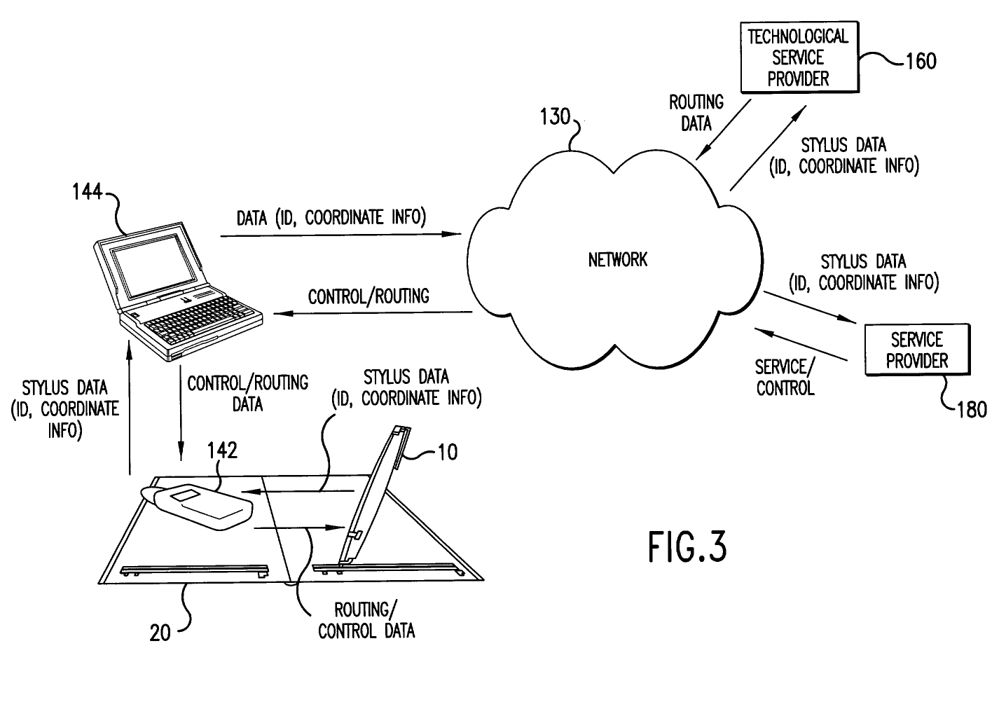

FIG. 3 illustrates an exemplary flow of information for elements of the end-user/network environment shown in FIG. 2. As seen in FIG. 3, the stylus 10 sends stylus data, which may include a stylus-specific identification (ID) and coordinate information, representing stylus position/movement data, to the technological service provider 160 via the network 130 and the intermediate communications device 140a, which includes a mobile phone 142a, e.g., with a Bluetooth RF transceiver, and a computer 144a in the exemplary end user environment of FIG. 3. Position information may include, for example, coordinates in the imaginary surface. It should be realized that the stylus 10 may store the coordinate information and/or other stylus data in memory for sending at a later occasion/time. The technological service provider 160 may use the stylus-specific ID information for various purposes, e.g., to access, verify, and update account information of individual end user 110a and/or to update billing/account information. The information transmitted by the stylus 10 may not be limited to stylus ID and coordinate information, depending on the capabilities of the stylus 10. For example, if the stylus 10 is provided with ICR capability, the stylus 10 may transmit text information.

The technological service provider 160 utilizes the coordinate information received from the stylus 10 to determine the type of service or transaction the user is requesting, e.g., based on the sub-surface associated with the coordinate information in the imaginary surface. Based on this determination, the technological service provider 160 identifies the service provider that will handle the service or transaction and sends routing data to the stylus 10 via the network 130 and the communications device 140a associated with the end user 110a. The routing data instructs the stylus 10 where, and in what format, to send the previously stored coordinate information, e.g., providing the stylus 10 with an Internet Protocol (IP) address for the server associated with the appropriate service provider 180. Next, the stylus 10 sends the previously-stored coordinate information to the appropriate service provider 180 via the communications device 140a and the network 130. Upon receiving and processing the coordinate information from the stylus 120, the service provider 180 may send control data back to the stylus 10, e.g., indicating that the service/transaction is complete so that the stylus 10 may clear its memory.

In addition to controlling routing and managing end user account information, it should be recognized that the technological service provider 160 may perform additional “value-added” services. For example, the technological service provider 160 may translate the coordinate information received from the stylus 10 into a format, e.g., text data, that may be used to achieve the requested service. Furthermore, the technological service provider 160 may itself perform any necessary routing, for example by transmitting the coordinate information received from the stylus 10 to the appropriate service provider.

The arrangements illustrated in FIGS. 2-3, and variations thereof, may support a variety of communications services and commercial transactions, such as:

Facsimile Service—The end user 110 may write a note or sketch on digital paper 20, input a facsimile number in a designated field of the digital paper 20, or at a keyboard, e.g., associated with a mobile telephone and check a portion of the surface 20 designated for a “send” function. The technological service provider 160 receives identification and coordinate data from the stylus 10, recognizes that the end user 110 has requested facsimile service, and sends appropriate routing information to the stylus 10, e.g., routing information for a service provider 180 that supports facsimile service. Upon receiving routing information from the technological service provider 160, the stylus 10 sends the previously-stored coordinate information to the service provider 180 supporting facsimile service, which converts the coordinate information into a facsimile transmission to the designated fax number.

Email—The end user 110 may write a note or sketch on the digital paper 20, input an email address in a designated field of the digital paper 20, or at a keyboard, e.g., associated with a mobile telephone and check a portion of the digital paper 20 designated for a “send” function. The technological service provider 160 will receive identification and coordinate data from the stylus 10, recognize that the end user 110 has requested email service, and send appropriate routing information to the stylus 10, e.g., routing information for a service provider 180 that supports email service. Upon receiving routing information from the technological service provider 160, the stylus 10 sends the previously-stored coordinate information to the service provider 180 supporting email service, which converts the coordinate information into an email message that is sent to the designated email address.

Short Message Service (SMS)—The end user 110 may write text on the digital paper 20, input a telephone number for an SMS-enabled device, e.g., a GSM mobile phone, in a designated field of the digital paper 20, or at a keyboard, e.g., associated with a mobile telephone and check a portion of the digital paper 20 designated for a “send” function. The technological service provider 160 receives identification and coordinate data from the stylus 10, recognizes that the end user 110 has requested SMS, and sends appropriate routing information to the stylus 10, e.g., routing information for a service provider 180 or network operator 170 that supports SMS. Upon receiving routing information from the technological service provider 160, the stylus 10 sends the previously-stored coordinate information to the network operator 170 or service provider 180 supporting SMS, which converts the coordinate information into a text message that is sent to the designated SMS-enabled device.

Commercial Transactions—The end user 100 may purchase goods or services using the stylus 10 and the digital paper 20. For example, an advertisement for flowers may be printed on the digital paper 20 with portions containing positioning identifying dot patterns. By touching an appropriate part of the advertisement with the stylus 10 and filling in order information, e.g., fields for name, address, credit card, delivery destination, etc., an order for flowers may be placed to a local flower shop, where the order can be filled.

Business Applications—Business end users 120a-120n may use the stylus 10 and the digital paper 20 in a manner similar to individual end users 110a-110n. A business end user 120 may either be an employee of or otherwise affiliated with a service provider in the arrangement. For example, a business end user 120a may be an employee of a parcel delivery service having an inventory system, and equip each delivery personnel with a stylus 10 and digital paper 20 for transmitting delivery status information to a host computer connected to the network 130. Depending on the particular business application, involvement of the technological service provider 160 may be optional.

2. Exemplary Fee/Billing Arrangements

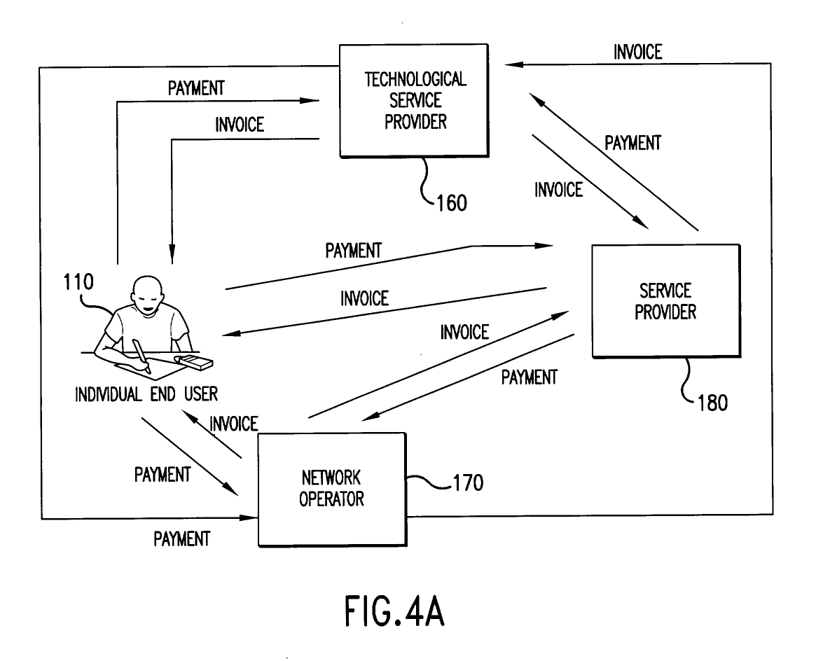

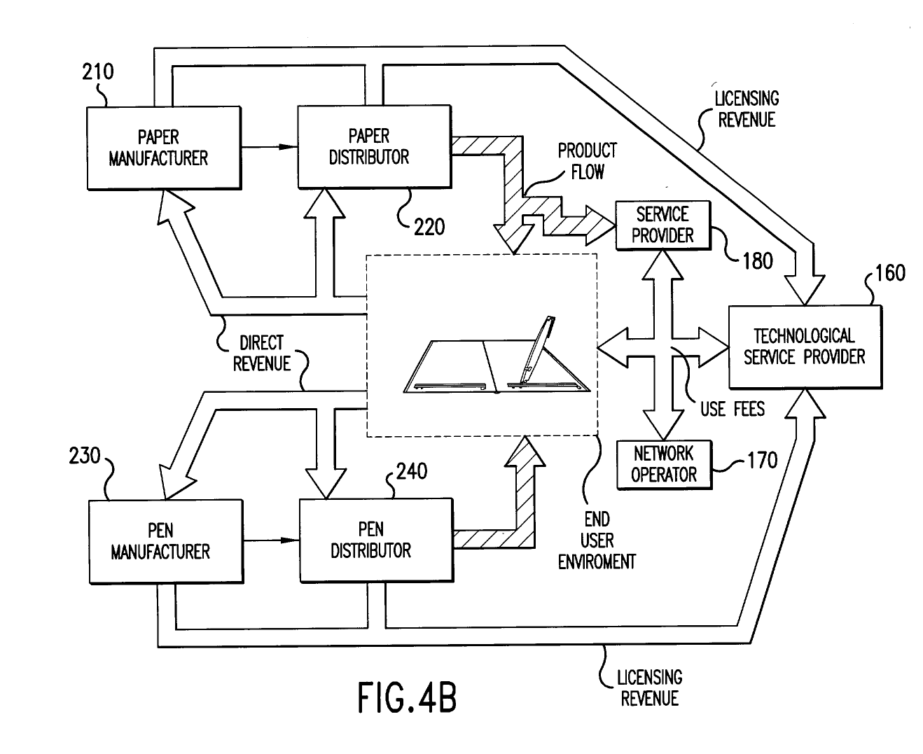

Various fee based revenue and billing arrangements among an individual end user 110, or business end user 120, a technological service provider 160, a network operator 170, and/or a service provider 180 may be implemented for the exemplary network and end user environments illustrated in FIGS. 1-3. FIG. 4A is a diagram showing several exemplary billing arrangements that could be implemented alone or in combination.

As can been seen in FIG. 4A, the technological service provider 160 may charge use-based fees to an individual end user 110. For example, fees may accrue for the end user 110 each time the technological service provider 160 generates routing information that enables a user-requested service, such as stylus/digital paper-based email or facsimile service. Alternatively, or in addition, the end user 110 may be charged by the technological service provider 160 on a service period basis, e.g., a monthly fee, or the technological service provider 160 may engage the service provider 180 to pass these fees directly to the consumer, including such fees on the bill issued by the service provider 180. Alternatively, or in addition, the technological service provider 160 may charge use based fees to the service provider 180. For example, fees may accrue for the service provider 180 each time the technological service provider 160 routes an end user 110 to the service provider 180, e.g., enabling the service provider 180 to engage in E-commerce with the end user 110. Alternatively, or in addition, the service provider 180 may be charged on a periodic basis, e.g., a monthly fee, for routing service and/or for an allocation of a sub-surface of the imaginary surface.

The service provider 180 may in turn charge a fee to the individual end user 110, depending on the service provided, e.g., a fee for each facsimile, email, SMS, or commercial transaction and/or a monthly fee. The network operator 170 may charge the end user 110, the service provider 180, and/or the technological service provider 160 for use of the communication channel used conduct stylus/digital paper-based services/transactions. Various fee and billing arrangements are described in detail in the co-pending application titled “Method and System for Supporting Infrastructure Delivery in a Computer Network” filed concurrently herewith, the entire contents of which are incorporated by reference.

3. Arrangement for Supporting the Technological Service Provider

Although the stylus/digital paper-based services supported by the exemplary network arrangements of FIGS. 1-3 provide numerous possibilities for fee and billing arrangements, the inventors of this application have recognized that charging fees for routing, sub-surface allocation, and/or other functions performed by the technological service provider 160 to an end user 110a or a service provider 180 may discourage investment by potential service providers in stylus/digital paper-based services and/or discourage use by end users, at least until the basic stylus/digital paper-based technological environment has proliferated and become an accepted form of input technology. Thus, despite the investment of the technological service provider 160 in developing and promoting the stylus/paper-based technology and services, and the costs of performing routing and other functions, the technological service provider 160 may be unable to generate sufficient fee revenue, at least until the stylus/digital paper-based input technology and services have become established. In this sense, the technological service provider 160 may essentially be in the position of subsidizing use by the end users 110, 120 and/or participation by service providers 180 by not passing along the cost associated with establishing and controlling stylus/digital paper-based technology and services. Over the long term, and without an offsetting revenue source, such subsidization cannot be maintained.

According to the present invention, an inability of the technological service provider 160 to generate sufficient fee based revenue is offset by licensing arrangements with manufacturers and/or distributors of stylus units and digital paper, thereby supporting the technological service provider 160. FIG. 4B is a diagram illustrating an exemplary arrangement for supporting the technological service provider 160 in accordance with embodiments of the present invention. In accordance with the present invention, the technological service provider 160 maintains a proprietary interest in the digital paper technology, e.g., via patent protection. As illustrated in FIG. 4B, the technological service provider 160 enters into a licensing revenue arrangement with paper manufacturers 210 and/or paper distributors 220 in exchange for rights that allow manufacture and/or sale of products associated with the proprietary digital paper technology, e.g., products having dots portions of the imaginary surface. In this way, the technological service provider 160 receives licensing revenue based on supply of digital paper to end users 110 and/or service providers 180 in lieu of, or as a supplement to, service fees.

In one embodiment of the present invention, the price paid by an end user 110 for digital paper includes “pre-paid” stylus/digital paper-based services. In other words, the technological service provider 160 does not charge the end user 110 a periodic fee or use based fees associated with routing, etc. This “pre-paid” aspect of the digital paper may be more convenient to the end user and may eliminate potentially confusing and inconvenient fee arrangements with the end user, thus encouraging the purchase of stylus/digital paper-based technology and use of stylus/digital paper-based services by end users. In other words, the end user 110 does not have to be concerned with downstream fees and billing. Such a “pre-paid” arrangement may enhance proliferation and acceptance of stylus/digital paper as a viable and convenient input technology for communications and services, thereby encouraging investment in new stylus/digital paper-based applications and services. Furthermore, the “pre-paid” arrangement for digital paper is beneficial to the technological service provider 160 because a unit of digital paper will typically be consumed each time the technological service provider 160 performs routing and, thus, the technological service provider 160 can implement a royalty arrangement with paper manufacturers 210 and/or paper distributors 220 that accurately correlates the per-unit royalty of digital paper with anticipated costs of performing the “pre-paid” technological service. To ensure the correlation between per-unit royalty and cost, the technological service provider 160 may, for example, impose limits on routing per unit of digital paper, e.g., limit service to one routing function per unit of digital paper. The technological service provider 160 may police such routing limits by recognizing when a particular unit of digital paper has already been used, e.g., based on position in the imaginary surface for a unit of digital paper.

It should be recognized that a service provider 180 may itself be a manufacturer or distributor of digital paper, particularly for digital paper bearing dot patterns for a sub-surface of the imaginary surface allocated to the service provider. Also, it should be recognized that the service provider 180 and the technological service provider 160 may share licensing revenue, such that the service provider 180 likewise does not charge periodic or use based fees to the end user 110.

As shown in FIG. 4B, the technological service provider 160 may enter into similar license fee arrangements with stylus manufacturers 230 and/or stylus distributors 240. In other words, the technological service provider 160 may maintain a proprietary, e.g., patent, interest in stylus technology to license such technology to stylus manufacturers 230 and/or stylus distributors 240. Although associated with lower volume, stylus licensing fees may supplement revenue generated through digital paper licensing fees.

Ultimately, the technological service provider 160 may benefit from wide-spread proliferation of stylus/digital paper-based technology and services and realize an ability to generate high levels of fee based revenue from sub-surface allocation and/or use based fee arrangements with service providers and/or end users.

4. Arrangement for Controlling Access to Digital Paper Services

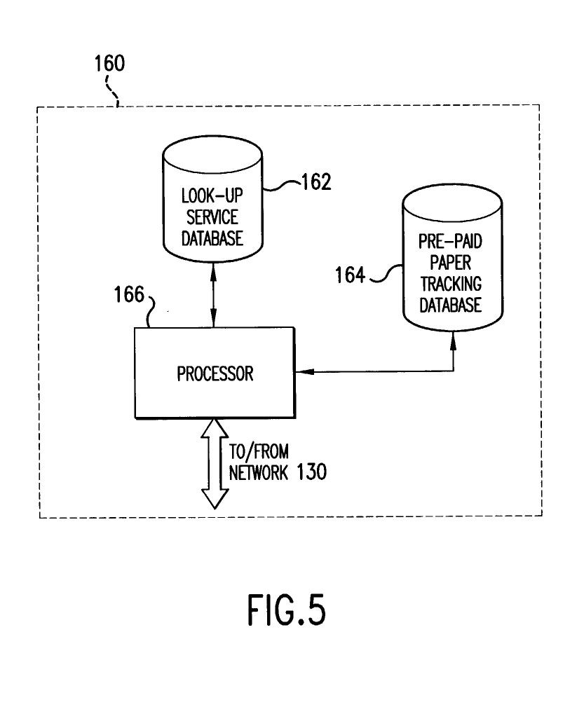

FIG. 5 illustrates an exemplary arrangement of the technological service provider 160 that allows the technological service provider 160 to limit repeated use of a unit of digital paper and prevent the use of forged digital paper. As shown in FIG. 5, the technological service provider 160 according to this implementation includes a look-up service database 162; a pre-paid paper tracking database 164; and a processor 166. It should be recognized that the technological service provider 160 will include other elements, such as communications links, to execute the functions described above and below. Furthermore, it should be recognized that the look-up service database 162 and the pre-paid paper tracking database 164 may be combined into a single database or implemented as multiple databases.

As discussed above, the imaginary surface may be divided into unique sub-surfaces of various size, some of which may be pre-defined for certain communications services, such as the facsimile, email, SMS, . . . , etc. services discussed above. In this way, a portion of the imaginary surface may be associated with pre-paid paper and individual units of pre-paid paper may be unique. Units of pre-paid paper may be sold in stores and/or could be downloaded, e.g., from a website, to be printed out by the user. In one implementation of the present invention, each unit of pre-paid paper, e.g., an individual sheet of paper or a collection of sheets, is assigned a unique identification number or some other form of identification information, for example using simple enumeration. The units of pre-paid paper may be selected randomly from the portion of the imaginary surface which is associated with pre-paid paper, thereby making forgery difficult. The pre-paid paper tracking database 164, which may reside on a server of the technological service provider 160, stores information regarding the status of all allocated pre-paid paper units and is organized according to the unique identification numbers of the pre-paid paper units. The pre-paid paper tracking database 164 includes service management information, such as entries for the number of allowable “charges,” i.e., uses, for each unique identification number and may also include the type of communications service associated with each identification number (optional). When the technological service provider 160 receives information from the stylus 10 via the network 130, including stylus ID and coordinate information as discussed above, the processor 166 determines whether the received coordinate information corresponds with a portion of the imaginary surface that has been assigned a unique identification number. More specifically, if the received coordinate information belongs to a region of the imaginary surface which has been allocated to a unit of pre-paid digital paper, the processor 166 will be able to retrieve a unique identification number corresponding to the received coordinate information. Using the unique identification number, the processor 166 checks the corresponding entries in the pre-paid paper tracking database 164 to determine whether any additional uses (“charges”) of the corresponding unit of digital paper are authorized. If yes, the processor 166 initiates the look-up service described above using the look-up service database 162 and decreases the number of allowed charges for the corresponding unit of digital paper by an appropriate amount, e.g., decreases by 1. It should be recognized that the number of allowable charges for some units of digital paper may initially be set at 1. If no additional uses of the corresponding unit of digital paper are authorized, the processor 166 lets the user of the stylus 10 know, e.g., by outputting a text message or error code to stylus 10, the user's PC, the user's cellular phone, and/or the user's PDA, etc. Furthermore, if the processor 166 determines that the received coordinate information corresponds to the portion of the imaginary surface which is associated with pre-paid paper but not to an allocated unit of pre-paid paper for use, it determines that user is likely using forged paper and outputs an error message to the user, e.g., to the stylus 10, the user's PC, the user's cellular phone, PDA, etc.

In the above-described implementation, the ability of the processor 166 to detect forged digital paper is a function of the percentage of the imaginary surface that has been allocated as units of pre-paid paper. It should be recognized, however, that only a fraction of the imaginary surface which is associated with pre-paid paper may be allocated, particularly in the initial years of use. Thus, there is only a slight chance that a user will be able to successfully forge digital paper, such a chance being proportional to the percentage of the imaginary surface which has been allocated for use. In practice, if 100 billion possible units of pre-paid paper exist and only 1 million are actually allocated, this will result in a possible forgery success rate of 0.001%. As discussed above, units of pre-paid paper may be selected randomly from the imaginary surface which is associated with pre-paid paper. When an additional unit of pre-paid paper is allocated for use, it is assigned an identification number and added to the pre-paid paper tracking database 164, along with information indicating the number of allowable charges and the associated service. Each time the technological service provider 160 performs a look-up for the unit, the number of allowable charges in the pre-paid paper tracking database 164 is decreased by an appropriate amount, e.g., is decreased by 1.

Although the above description specifies the pre-paid paper tracking database 164 is utilized by the technological service provider 160, such a database may instead, or additionally, be utilized by a service provider, or some other network node, to track the use of pre-paid paper and/or prevent forgery.

5. Reference to Related Applications

Co-pending with the application for this patent are applications entitled Systems and Methods for Information Storage based on Swedish Application No. 0000947-2, filed Mar. 21, 2000, U.S. Provisional Application No. 60/207,839, filed May 30, 2000, and U.S. Utility application Ser. No. 09/812,885, filed on Mar. 21, 2001; Secured Access Using a Coordinate System based on Swedish Application No. 0000942-3, filed Mar. 21, 2000, U.S. Provisional Application No. 60/207,850 filed on May 30, 2000, and U.S. Utility application Ser. No. 09/813,115, filed on Mar. 21, 2001; System and Method for Printing by Using a Position Coding Pattern based on Swedish Application No. 0001245-0, filed on Apr. 5, 2000, U.S. Provisional Application No. 60/210,651, filed on Jun. 9, 2000, and U.S. Utility application Ser. No. 09/812,905, filed on Mar. 21, 2001; Apparatus and Methods Relating to Image Coding based on Swedish Application No. 0000950-6, filed on Mar. 21, 2000, U.S. Provisional Application No. 60/207,838, filed on May 30, 2000, and U.S. Utility application Ser. No. 09/812,901, filed on Mar. 21, 2001; Apparatus and Methods for Determining Spatial Orientation based on Swedish Application No. 0000951-4, filed on Mar. 21, 2000, U.S. Provisional Application No. 60/207,844, filed on May 30, 2000, and U.S. Utility application Ser. No. 09/812,902, filed on Mar. 21, 2001; System and Method for Determining Positional Information based on Swedish Application No. 0000949-8, filed Mar. 21, 2000, U.S. Provisional Application No. 60/207,885, filed on May 30, 2000, and U.S. Utility application Ser. No. 09/812,900, filed on Mar. 21, 2001; Method and System for Transferring and Displaying Graphical Objects based on Swedish Application No. 0000941-5, filed Mar. 21, 2000, U.S. Provisional Application No. 60/208,165, filed May 31, 2000, and U.S. Utility application Ser. No. 09/812,892, filed on Mar. 21, 2001; Online Graphical Message Service based on Swedish Application No. 0000944-9, filed Mar. 21, 2000, U.S. Provisional Application No. 60/207,881, filed May 30, 2000, and U.S. Utility application Ser. No. 09/813,117, filed on Mar. 21, 2001; Method and System for Digitizing Freehand Graphics With User-Selected Properties based on Swedish Application No. 0000945-6, filed Mar. 21, 2000, U.S. Provisional Application No. 60/207,882, filed May 30, 2000, and U.S. Utility application Ser. No. 09/812,882, filed on Mar. 21, 2001; Data Form Having a Position-Coding Pattern Detectable by an Optical Sensor based on Swedish Application No. 0001236-9, filed Apr. 5, 2000, U.S. Provisional Application No. 60/208,167, filed May 31, 2000, and U.S. Utility application Ser. No. 09/812,906, filed on Mar. 21, 2001; Method and Apparatus for Managing Valuable Documents based on Swedish Application No. 0001252-6, filed Apr. 5, 2000, U.S. Provisional Application No. 60/210,653 filed Jun. 9, 2000, and U.S. Utility application Ser. No. 09/813,116, filed on Mar. 21, 2001; Method and Apparatus for Information Management based on Swedish Application No. 0001253-4 filed Apr. 5, 2000, U.S. Provisional Application No. 60/210,652, filed Jun. 9, 2000, and U.S. Utility application Ser. No. 09/826,015, filed on Apr. 5, 2001; Device and Method for Communication based on Swedish Application No. 0000940-7, filed Mar. 21, 2000, U.S. Provisional Application No. 60/208,166, filed May 31, 2000, and U.S. Utility application Ser. No. 09/813,114, filed on Mar. 21, 2001; Information-Related Devices and Methods based on Swedish Application No. 0001235-1, filed Apr. 5, 2000, U.S. Provisional Application No. 60/210,647, filed Jun. 9, 2000, and U.S. Utility application Ser. No. 09/812,907, filed on Mar. 21, 2001; Processing of Documents based on Swedish Application No. 0000954-8, filed Mar. 21, 2000, U.S. Provisional Application No. 60/207,849, filed May 30, 2000, and U.S. Utility application Ser. No. 09/813,112, filed on Mar. 21, 2001; Secure Signature Checking System based on Swedish Application No. 0000943-1, filed Mar. 21, 2000, U.S. Provisional Application No. 60/207,880, filed May 30, 2000, and U.S. Utility application Ser. No. 09/812,899, filed on Mar. 21, 2001; Identification of Virtual Raster Pattern, based on Swedish Application No. 0001235-1, filed Apr. 5, 2000, U.S. Provisional Application No. 60/210,647, filed Jun. 9, 2000, U.S. Utility application Ser. No. 09/812,907, filed on Mar. 21, 2001, and Swedish Application No. 0004132-7, filed Nov. 10, 2000, and U.S. Provisional Application No. 60/261,123, filed Jan. 12, 2001; Method and Arrangment in a Digital Communication System based on Swedish Application No. 0102232-6, filed Jun. 25, 2001; Communication Protocol based on Swedish Application No. 0102418-1, filed Jul. 5, 2001, and U.S. Provisional Application No. 60/303,814 filed Jul. 10, 2001; Method and System for Communications Service Revenue Collection based on U.S. Provisional Application No. 60/281,786, filed Apr. 6, 2001; Activation of Products with Embedded Functionality in an Information Management System based on Swedish Application No. 0104398-3, filed Dec. 27, 2001, and U.S. Provisional Application No. 60/346,295, filed Jan. 9, 2002; Server Unit in Computer Network based on Swedish Application No. 0102341-5, filed Jun. 29, 2001, and U.S. Provisional Application No. 60/303,041, filed Jul. 6, 2001.

The technical disclosures of each of the above-listed U.S. applications, U.S. provisional applications, and Swedish applications are hereby incorporated herein by reference. As used herein, the incorporation of a “technical disclosure” excludes incorporation of information characterizing the related art, or characterizing advantages or objects of this invention over the related art.

The invention being thus described, various modifications will be readily apparent to those skilled in the art. Such variations are not to be regarded as a departure from the spirit and scope of the invention, and all such modifications are intended to be included within the scope of the following claims.

What is claimed is:

1. A system for receiving and communicating user-input information via a network, said system comprising:
a position indicia reading stylus, said stylus collecting position information from a product having position defining indicia printed thereon, said position information representing the position of said stylus on said product; and
a network infrastructure for communicating a signal representing, or derived from, said position information collected from said stylus to a network node that performs a technological service based on said signal, funds for supporting said network node being derived from a licensing arrangement associated with at least one of said product and said stylus.

2. The system of claim 1, wherein said product has a position-defining background pattern thereon, portions of said background pattern having dots displaced from a virtual grid structure.

3. The system of claim 2, wherein said portions uniquely define positions on said product which map to an imaginary surface.

4. The system of claim 3, wherein said imaginary surface is divided into sub-surfaces associated with different services.

5. The system of claim 4, wherein said different services include email, facsimile services, and SMS service.

6. The system of claim 1, wherein said network node has a proprietary interest in technology related to at least one of said product and said stylus.

7. The system of claim 1, wherein finds for supporting said network node are derived from a licensing arrangement associated with said product.

8. The system of claim 1, wherein funds for supporting said network node are derived from a licensing arrangement associated with said stylus.

9. The system of claim 1, wherein said digital paper includes at least one location-specific indicia that represents a function command.

10. The system of claim 9, wherein said function command is a send command that enables said user to initiate communication of said signal via said network infrastructure.

11. The system of claim 1, wherein finds for supporting said network node are derived from a licensing arrangement associated with said product and said stylus.

12. The system of claim 7, wherein users that purchase said product are not otherwise billed for said technological service.

13. The system of claim 1, wherein said stylus is a digital pen having a camera and a transceiver element for communicating position information and pen identification information to the network node via said network infrastructure.

14. A system for receiving and communicating user-input information via a network, said system comprising:
a position indicia reading stylus operated by an end user, said stylus collecting position information from a product having position defining indicia printed thereon, said position information representing the position of said stylus on said product; and
a network infrastructure for communicating a signal representing, or derived from, said position information collected from said stylus to a network node that performs a technological service based on said signal, purchase of said stylus and/or product by said end user serving to pre-pay for said technological service, such that said end user is not otherwise billed for said technological service.

15. A system for receiving and communicating user-input information via a network, said system comprising:
a position indicia reading stylus, said stylus collecting position information from a product having position defining indicia printed thereon, said position information representing the position of said stylus on said product; and
a network infrastructure for communicating a signal representing, or derived from, said position information collected from said stylus to a network node that performs a technological service based on said signal, finds for supporting said network node being derived from a licensing arrangement associated with said product, said product being consumed upon performance of said technological service by said network node.

16. A method for offsetting costs associated with a technology service in which an end user uses a position indicia reading stylus to collect position information from a product having position identifying indicia thereon and a network infrastructure communicates a signal representing, or derived from, position information collected from said stylus to a network node that performs a technological service based on said signal, said method comprising:
establishing a licensing agreement associated with at least one of said product and said stylus; and
distributing funds generated pursuant to said license agreement to said network node, thereby allowing said network node to at least partially offset costs associated with said technological service.

17. The method of claim 16, wherein said product has a position-defining background pattern thereon, portions of said background pattern having dots displaced from a virtual grid structure.

18. The method of claim 17, wherein said portions uniquely define positions on said product which map to an imaginary surface.

19. The method of claim 18, wherein said imaginary surface is divided into sub-surfaces associated with different services.

20. The method of claim 19, wherein said different services include email, facsimile services, and SMS service.

21. The method of claim 16, wherein said network node has a proprietary interest in technology related to at least one of said product and said stylus.

22. The method of claim 16, wherein funds for offsetting costs associated with said network node are derived from a licensing arrangement associated with said product.

23. The method of claim 16, wherein funds for supporting said network node are derived from a licensing arrangement associated with said stylus.

24. The method of claim 16, wherein said digital paper includes at least one location-specific indicia that represents a function command.

25. The method of claim 24, wherein said function command is a send command that enables said stylus to initiate communication of said signal via said network infrastructure.

26. The method of claim 16, wherein funds for supporting said network node are derived from a licensing arrangement associated with said product and said stylus.

27. The method of claim 22, wherein end users that purchase said product are not otherwise billed for said technological service.

28. The method of claim 16, wherein said stylus is a digital pen having a camera and a transceiver element for communicating position information and pen identification information to the network node via said network infrastructure.

29. A method for offsetting costs associated with a technology service in which an end user uses a position indicia reading stylus to collect position information from a product having position identifying indicia thereon and a network infrastructure communicates a signal representing, or derived from, position information collected from said stylus to a network node that performs a technological service based on said signal, said method comprising:
establishing a licensing agreement associated with at least one of said product and said stylus; and
providing said stylus and/or product to said end user for a price, the price paid by said end user for said stylus and/or product serving to pre-pay said technological service, such that said end user is not otherwise billed for said technological service.

30. A method for offsetting costs associated with a technology service in which an end user uses a position indicia reading stylus to collect position information from a product having position identifying indicia thereon and a network infrastructure communicates a signal representing, or derived from, position information collected from said stylus to a network node that performs a technological service based on said signal, said method comprising:
establishing a licensing agreement associated with said product, said product being consumed upon performance of said technological service by said network node; and
distributing funds generated pursuant to said license agreement to said network node, thereby allowing said network node to at least partially offset costs associated with said technological service.

31. A method of controlling access to communications services, comprising:
receiving position information from a position indicia reading stylus, said stylus collecting position information from a product having position defining indicia printed thereon, said position information representing the position of said stylus on said product;
determining whether the received position information corresponds to previously-assigned identification information and, if so, retrieving service management information designated for the previously-assigned identification information; and
selectively permitting access to a communications service in accordance with the retrieved service management information.

32. The method according to claim 31, wherein said product is a unit of digital paper and said service management information indicates a number of uses authorized for said unit of digital paper.

33. The method according to claim 31, wherein said method further comprises:
selectively outputting a non-authorization message to the user of said stylus in accordance with the retrieved service management information.

34. The method according to claim 31, further comprising:
judging that the product used to generate the position information is forged when said step of determining determines that the received position information does not correspond to previously-assigned identification information.

35. A system for controlling access to communications services, comprising:
an input for receiving position information from a position indicia reading stylus, said stylus collecting position information from a product having position defining indicia printed thereon, said position information representing the position of said stylus on said product; and
a processor for determining whether the received position information corresponds to previously-assigned identification information and, if so, retrieving service management information designated for the previously-assigned identification information, said processor selectively permitting access to a communications service in accordance with the retrieved service management information.

36. The system according to claim 35, wherein said product is a unit of digital paper and said service management information indicates a number of uses authorized for said unit of digital paper.

37. The system according to claim 35, wherein said processor selectively outputs a non-authorization message to the user of said stylus in accordance with the retrieved service management information.

38. The system according to claim 35, wherein said processor judges that the product used to generate the position information is forged upon determining that the received position information does not correspond to previously-assigned identification information.
